(19) United States
(12) Patent Application Publication
(10) Pub. No.: US 2026/0274321 A1
(43) Pub. Date: Sep. 17, 2026

(54) TURN-OVER STRUCTURE LINKING WHEELS UPON FOLDING A STROLLER

(71) Applicant: Yongxiang CHEN, Zhong Shan City (CN)

(72) Inventor: Yongxiang CHEN, Zhong Shan City (CN)

(21) Appl. No.: 19/077,414

(22) Filed: Mar. 12, 2025

(51) Int. Cl. B62B 7/06; B62B 7/08

(52) U.S. Cl. CPC B62B 7/064; B62B 7/08; B62B 2205/06; B62B 2205/20

(57) ABSTRACT

A turn-over structure linking wheels upon folding a stroller includes a pair of side bar, and lower bar, a carrying frame, and a pair of side bottom bar. A tail end of the lower bar is pivoted to the side bottom bar, two side bars and a pair of support handle are pivoted to the carrying frame, a front side and a rear side of the side bottom bars are pivoted to a front wheel set and a rear wheel set respectively, and the lower bar and the support handle form an intersection state in an X-shape. Each one of two movable rods passes through and moves in the side bottom bar; whereas when folding the stroller, the movable rod is linked and pulled backward altogether, and the backward movement of the movable rod drives the front wheel set and the rear wheel set to flip inward for collection.

### BACKGROUND OF THE INVENTION

### (a) Field of the Invention

The present invention relates to a turn-over structure linking wheels upon folding a stroller, and more particularly to a turn-over structure linking wheels upon folding a stroller, wherein a front wheel set and a rear wheel set are linked to flip inward together for collection when folding the stroller, so as to reduce the height of stroller without operating to fold the front wheel set and the rear wheel set to flip inward again.

### (b) Description of the Prior Art

As we know, a conventional baby stroller facilitates a care-taker to put a baby in the stroller to push it when going out, so that the baby can get in touch with outdoor environment and the care-taker can carry the baby easily. Therefore, the baby stroller is a necessary baby product for ordinary parents and care-takers, and is very convenient as it gets rid of the inconvenience in holding the baby with arms. However, the functions of baby stroller are not merely limited to this; the baby stroller can be folded to reduce the size so that the baby stroller can be put into a vehicle easily without taking up space. In addition, the baby stroller can be transported and stored conveniently. Accordingly, the baby stroller must have a folding structure to meet the requirements of general public.

Although the conventional baby stroller is equipped with the folding and expanding structure, the front and rear wheels always take up certain space (height). Therefore, if the storage space of a mini car is insufficient, the folded baby stroller will not be collected into the mini car easily, which troubles the care-takers very much.

On the existing market, a push cart for carrying objects is equipped with a platform, a handle, two front wheels and two rear wheels. The platform is used for carrying objects, the handle is pivoted to a rear end of the platform, and the two front wheels and two rear wheels are pivoted to a bottom of the platform. Furthermore, the push cart is also provided with a handle folding device, a front wheel folding device, and a rear wheel folding device. The handle folding device is used to fold or expand the handle, the front wheel folding device is used to flip and fold the two front wheels inward or flip and expand the two front wheels into an upright position, and the rear wheel folding device is used to flip and fold the two rear wheels inward or flip and expand the two rear wheels into an upright position. In folding the push cart, the operations must be carried out in order. First, the two front wheels are flipped inward, then the two rear wheels are flipped inward, and finally, the handle is folded forward to lie flat on the platform. It will require three operations to accomplish the folding. Although the size and height of the push cart are reduced after folding, it is not very convenient for an operator, as he or she needs to complete three operations actually to fold, which takes time and labor work.

The existing conventional baby stroller is only provided with the folding structure, without a structure for folding and flipping the front and rear wheels, or a structure for linking the front and rear wheels to flip and fold at a same time when folding the baby stroller. Therefore, if the front and rear wheels can be linked to flip and fold when folding the baby stroller, it can further reduce the size after folding and even facilitate accomplishing the entire folding by one operation for the parents or care-takers, which is a big benefit to the parents or care-takers. On the other hand, the push cart is not either provided with the structure for linking the front and rear wheels to flip for collection at a same time when folding the push cart, which is indeed inconvenient to users.

### SUMMARY OF THE INVENTION

Accordingly, the present invention is to provide a turn-over structure linking wheels upon folding a stroller. The stroller includes a pair of side bar and a carrying frame.

An upper side of the side bar is connected to a grab rail, and a lower side of the side bar is connected to a turning lock button. The turning lock button is pivoted to a lower bar, and a tail end of the lower bar is pivoted to a side bottom bar. An inner side of the side bar is provided with a push button which connects a steel cable to the turning lock button. Sliding the push button can release the locking between the side bar and the lower bar, and the side bar and the lower bar change into a flipped and folded state from an original straight and expanded state. A bottom of the lower bar provides for connecting the side bottom bar, a front side of the side bottom bar is pivoted to a front wheel set, and a rear side of the side bottom bar is pivoted to a rear wheel set.

The carrying frame is a frame body, and each of two sides thereof is pivoted to one side bar respectively. An upper end of a pair of support handle is pivoted to the carrying frame, and a lower end of the support handle is pivoted to a movable rod. A middle end of the support handle is pivoted to a roughly middle position on the inner side of the lower bar, forming an intersection state in an X-shape between the lower bar and the support handle.

The present invention is characterized in that the side bar is provided with a front tube, a connection handle, and a rear tube. The connection handle connects the front tube and the rear tube, the movable rod passes through the front tube and the rear tube, a front side of the movable rod is provided with two symmetric front pillars, and a rear side of the movable rod is provided with two symmetric rear pillars. An upper side on top of the front wheel set is provided with a front sleeve, the front sleeve is provided with two symmetric front arc-shaped chutes, and the front pillars are disposed in the front arc-shape chutes. An upper side on top of the rear wheel set is provided with two symmetric rear sleeves, each rear sleeve is provided with two symmetric rear arc-shaped chutes, and the rear pillars are disposed in the rear arc-shaped chutes. When folding the baby stroller, the support handle changes into an even tilted state from a tiled state, and the movable rod is pulled backward to link the front sleeve and the rear sleeves to change direction, allowing the front wheel set and the rear wheel set to turn inward for collection altogether.

A primary object of the present invention is to provide a turn-over structure linking wheels upon folding a stroller, that when folding the stroller, the two front wheel sets and the two rear wheel sets are flipped altogether, without needing a second operation to flip the two front wheel sets and the two rear wheel sets, which is very convenient in operation.

A second object of the present invention is to provide a turn-over structure linking wheels upon folding a stroller, that after folding the stroller, the height and size of the stroller are reduced, so that the stroller can be stored and transported easily.

A third object of the present invention is to provide a turn-over structure linking wheels upon folding a stroller, that after completely expanding the stroller, the two front wheel sets and the two rear wheel sets can be flipped to form an upright position by one expansion operation too, without a second operation.

A fourth object of the present invention is to provide a turn-over structure linking wheels upon folding a stroller, which can be used widely that the structure can be pushed for walking, can be pulled, can be used to carry objects, can be used as a baby stroller, and can be used as a camping cart or a shopping cart.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional exploded view of the present invention.

FIG. 2 shows a three-dimensional exploded view of a side bottom bar, a lower bar, and a movable rod, according to the present invention.

FIG. 3 shows a three-dimensional exploded view of a turning lock button of the present invention.

FIG. 4 shows a three-dimensional assembly view of the present invention.

FIG. 5 shows a three-dimensional view of the present invention in a semi-folded state.

FIG. 6 shows a three-dimensional view of the present invention in a folded state.

FIG. 7 shows a cutaway view related to a push button in the side bar, according to the present invention.

FIG. 8 shows a cutaway view of the turning lock button in a locked state, according to the present invention.

FIG. 9 shows a cutaway view of the turning lock button in a released state, according to the present invention.

FIG. 10 shows a three-dimensional view of a front wheel set in an upright position, according to the present invention.

FIG. 11 shows a three-dimensional view of that the movable rod drives the front wheel set backward to flip inward, according to the present invention.

### DETAILED DESCRIPTION OF THE PREFERRED EMBODIMENTS

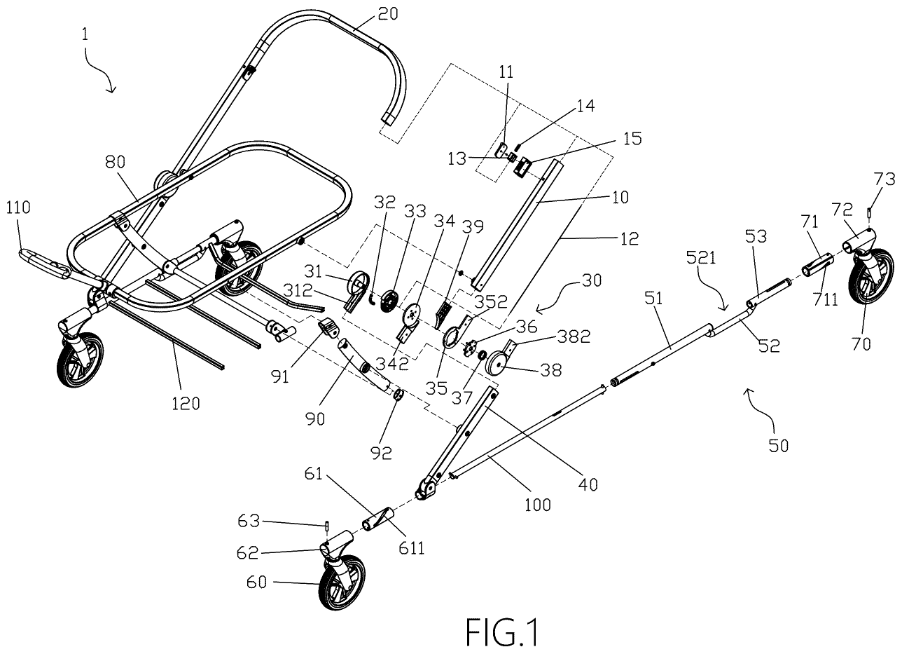

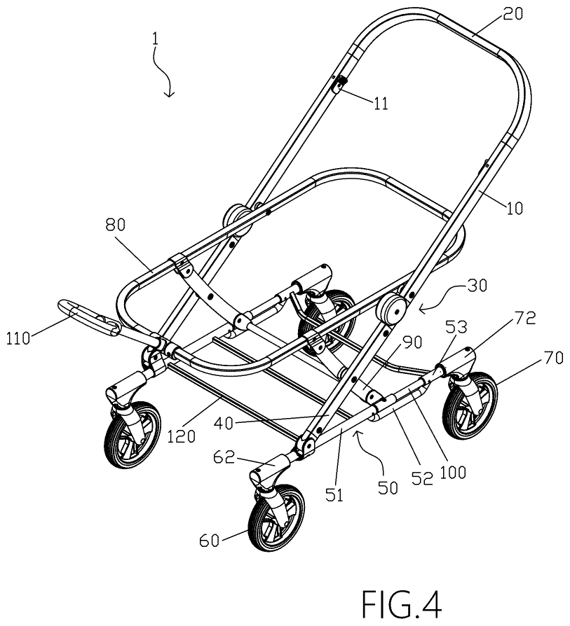

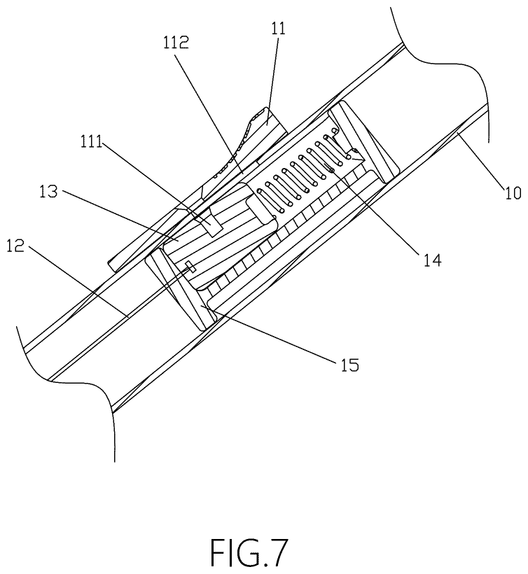

Referring to FIGS. 1 to 4, a stroller 1 includes a pair of side bar 10, a grab rail 20, two turning lock buttons 30, a pair of lower bar 40, a pair of side bottom bar 50, a pair of front wheel set 60, a pair of rear wheel set 70, and a carrying frame 80. An upper side of the side bar 10 is connected to the grab rail 20 in an inverted-U shape, a lower side of the side bar 10 is connected to the turning lock button 30, the turning lock button 30 is pivoted to the lower bar 40, a tail end of the lower bar 40 is pivoted to the side bottom bar 50, an inner side of the side bar 10 is provided with a push button 11 which connects a steel cable 12 to the turning lock button 30, the push button 11 outside the inner side of the side bar 10 is provided with a combining pillar 111 (as shown in FIG. 7), and the inner side of the side bar 10 is provided with a straight slot 112 for the displacement of the combining pillar 111. The combining pillar 111 is combined with a pull block 13, the pull block 13 connects the steel cable 12, and a top end of the pull block 13 abuts a spring 14. An interior of the side bar 10 is positioned with a limiting element 15, and the limiting element 15 is closed at top and bottom, allowing the pull block 13 and the spring 14 to be assembled inside the limiting element 15. The pull block 13 is pressed by the spring 14 to restore to its original position, and sliding the push button 11 can pull the steel cable 12. The linking of the steel cable 12 can release the locking between the side bar 10 and the lower bar 40 (to be described later), so that the side bar 10 and the lower bar 40 can change into a flipped and folded state from the original straight and expanded state. A bottom of the lower bar 40 provides for connecting the side bottom bar 50, a front side of the side bottom bar 50 is pivoted to the front wheel set 60, and a rear side of the side bottom bar 50 is pivoted to the rear wheel set 70.

The carrying frame 80 is a frame body assembled from plural rods. On each side of the carrying frame 80 and at a location in the roughly middle position toward the rear side by a small distance, one side bar 10 is pivoted. On the other hand, on each side of the carrying frame 80 and at a location roughly below the middle position toward the front side by a small distance, one support handle 90 is pivoted. A lower end of the support handle 90 is pivoted to a movable rod 100, and a middle end of the support handle 90 is pivoted to a roughly middle position inside the lower bar 40, forming an intersection state in an X-shape between the lower bar 40 and the support handle 90. A top end of the support handle 90 is pivoted to the carrying frame 80 by a double lug 91, and a bottom end of the support handle 90 is pivoted to the lower bar 40 by a bottom ring 92. A front end of the carrying frame 80 is pivoted to a front pull handle 110 (or without), and three horizontal bridging rods 120 are connected between the two side bottom bars 50.

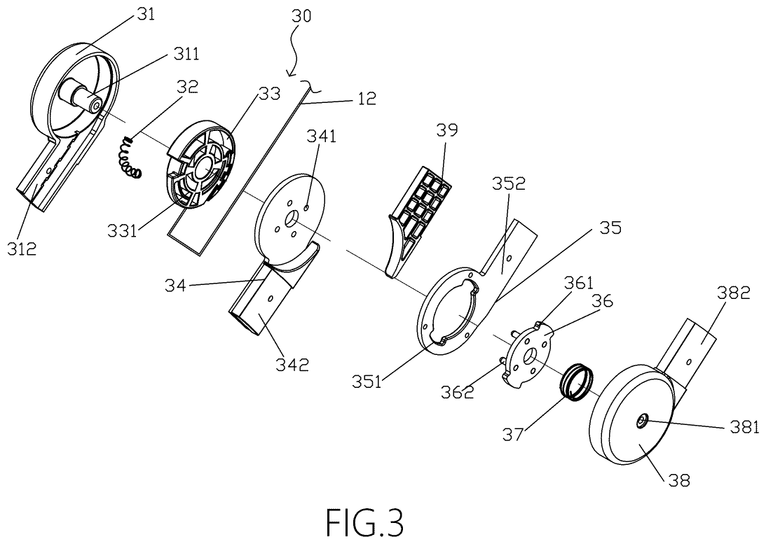

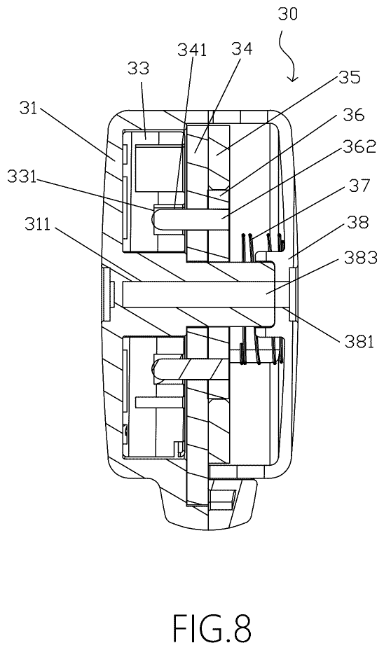

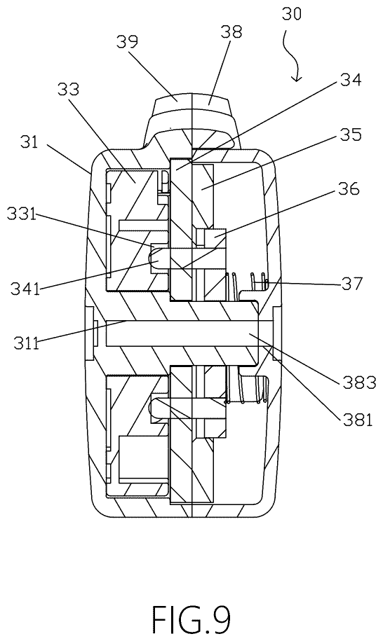

As shown in FIG. 1 and FIG. 3, the turning lock button 30 includes an inner housing 31, a micro compression spring 32, a turning element 33, a lower bar top locking element 34, a side bar bottom locking element 35, a latching element 36, a compression spring 37, and an outer housing 38. The inner housing 31 has a shaft 311, the outer housing 38 has a shaft hole 381, and the shaft 311 and the shaft hole 381 are combined by a stud bolt 383 (as shown in FIG. 8 and FIG. 9). The inner housing 31 and the outer housing 38 are combined together to assemble the micro compression spring 32, the turning element 33, the lower bar top locking element 34, the side bar bottom locking element 35, the latching element 36, and the compression spring 37. A lower side of the inner housing 31 is provided with a lower handle 312. The turning element 33 is linked to rotate by the steel cable 12 connected to the push button 11 as shown in FIG. 7. The turning element 33 abuts the micro compression spring 32 and can restore to the original position by the pressing of micro compression spring 32. Two symmetric arc-shaped grooves 331 are disposed outside the turning element 33, and the depth of arc-shaped groove 331 increases gradually, forming a lower to higher contact face (as shown in FIG. 3, FIG. 8, and FIG. 9). The lower bar top locking element 34 is a round plate and is provided with plural snap-in holes 341. A lower side of the lower bar top locking element 34 is provided with a secondary lower handle 342, and the secondary lower handle 342 is combined to a lower handle 312. After the secondary lower handle 342 is combined with the lower handle 312, the two are disposed in a top end of the lower bar 40. The side bar bottom locking element 35 is a round ring, and contains two locking notches 351. An upper side of the side bar bottom locking element 35 is provided with a secondary upper handle 352. The latching element 36 is a round plate, and an outer periphery thereof is provide with two protruded locking plates 361; whereas, an inner surface is provided with plural protruded latch pins 362. The locking plate 361 can be locked into the locking notch 351 of the side bar bottom locking element 35. The latch pin 362 can be inserted into the snap-in hole 341 of the lower bar top locking element 34 and can be abutted into the arc-shaped groove 331 touching the turning element 33. An outer side of the latching element 36 is abutted by the compression spring 37 inside the outer housing 38, and the latching element 36 is pressed by the compression spring 37 to restore to the original position. An upper side of the outer housing 38 is provided with an upper handle 382, a positioning side upper handle 39 is combined with the upper handle 382 and the secondary upper handle 352 of the side bar bottom locking element 35, combining together into a bottom end of the side bar 10 (the abovementioned structures and devices belong to the conventional technology, and their operations are the same as the conventional methods).

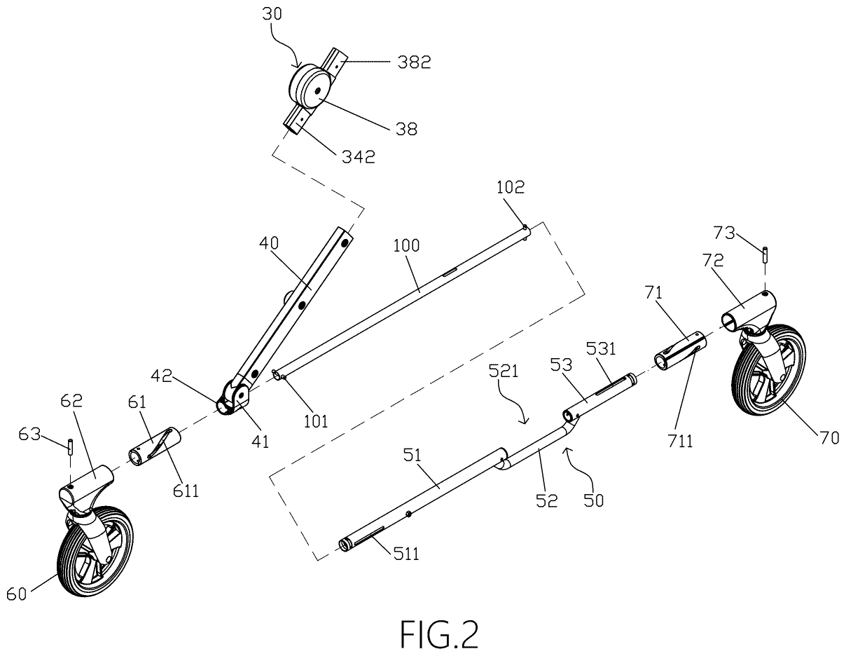

As shown in FIG. 1 and FIG. 2, the present invention is characterized in that the side bottom bar 50 is assembled from a front tube 51, a connection handle 52, and a rear tube 53. The connection handle 52 connects the front tube 51 and the rear tube 53, and the outer diameter of the movable rod 100 is a little smaller that it can pass through the front tube 51 and the rear tube 53. A gap 521 is disposed between the front tube 51 and the rear tube 53, and the connection handle 52 is disposed in the gap 521. The gap 521 provides for the movement of a pivot place between the movable rod 100 and the support handle 90. A bottom end of the lower bar 40 is provided with a pivoting double lug 41 and a short round tube 42. The short round tube 42 provides for connecting the front tube 51. A front side of the movable rod 100 is provided with two symmetric front pillars 101, and a rear side of the movable rod 100 is provided with two symmetric rear pillars 102. An upper side on top of the front wheel set 60 contains a front sleeve 61, and the front sleeve 61 is provided with two symmetric front arc-shaped chutes 611. The front pillar 101 is disposed in the front arc-shaped chute 611. A top of the front wheel set 60 is provided with a front horizontal cylinder 62, and the front horizontal cylinder 62 is combined with the front sleeve 61 by a front insert pin 63, allowing the front horizontal cylinder 62 and the front sleeve 61 to change direction simultaneously. An upper side on top of the rear wheel set 70 contains a rear sleeve 71, and the rear sleeve 71 is provided with two symmetric rear arc-shaped chutes 711. The rear pillar 102 is disposed in the rear arc-shaped chute 711. A top of the rear wheel set 70 is provided with a rear horizontal cylinder 72, and the rear horizontal cylinder 72 is combined with the rear sleeve 71 by a rear insert pin 73, allowing the rear horizontal cylinder 72 and the rear sleeve 71 to change direction simultaneously. The front tube 51 of the side bottom bar 50 is provided with a front chute 511, and the front chute 511 provides for the front pillar 101 of the movable rod 100 to enter and displace. The rear tube 53 of the side bottom bar 50 is provided with a rear chute 531, and the rear chute 531 provides for the rear pillar 102 of the movable rod 100 to enter and displace. When folding the baby stroller 1, the support handle 90 changes into an even tilted state from a tilted state, and pulls backward the movable rod 100. The movable rod 100 links the front sleeve 61 and the rear sleeve 71 to change direction, allowing the two front wheel sets 60 and the two rear wheel sets 70 to flip inward altogether for collection at a same time.

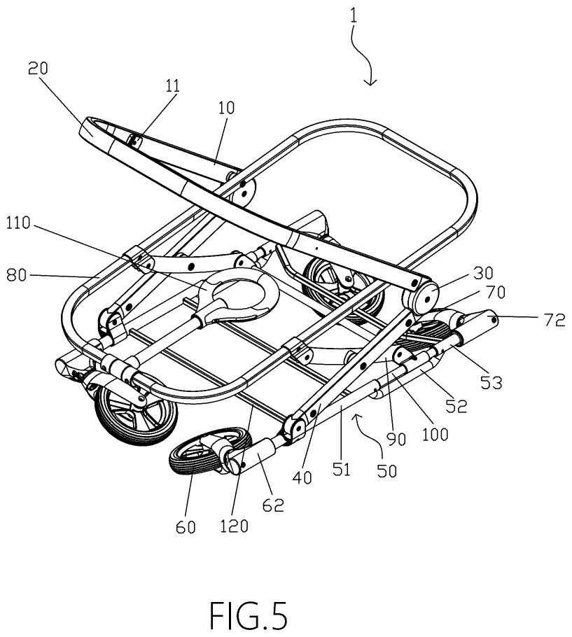

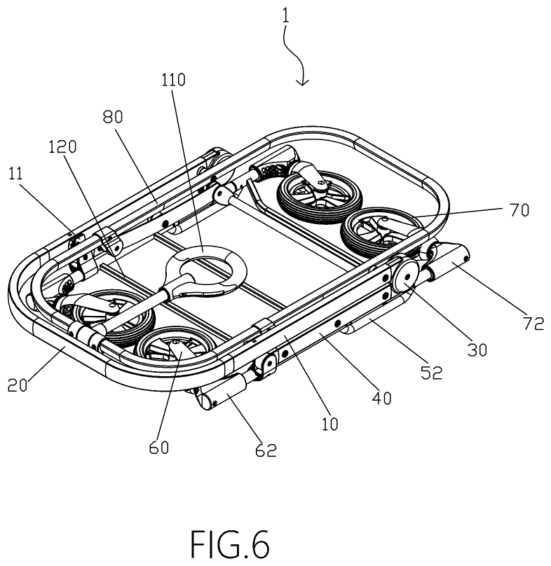

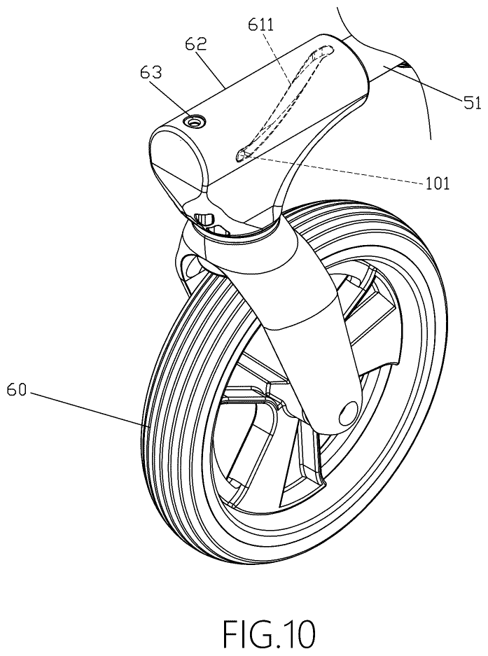

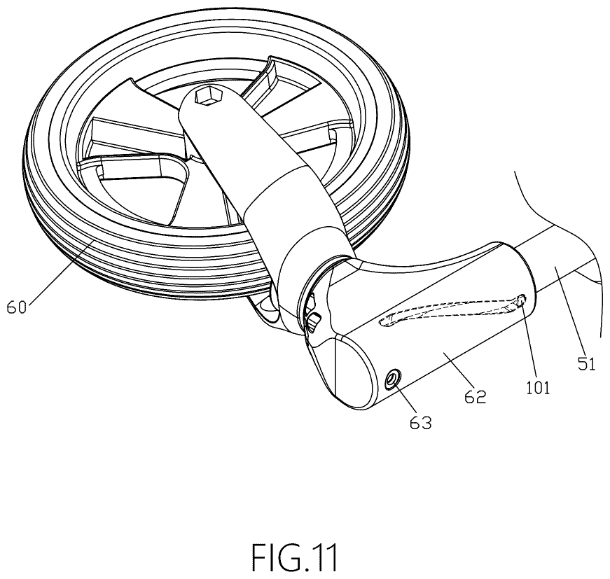

According to the abovementioned structure improvement, the operations are like an ordinary stroller, without extra operations. As shown in FIG. 1, FIG. 7, FIG. 8, and FIG. 9, first, two push buttons 11 on the inner sides of two side bars 10 are pushed upward by fingers of both hands. The push button 11 will pull upward the steel cable 12, the steel cable 12 will then pull the turning element 33 of the turning lock button 30 to rotate by an angle (the operations so far are all like the conventional methods). The arc-shaped groove 331 of the turning element 33 will next rotate and displace from the lower contact face to the higher contact face. The latch pin 362 will touch the higher contact face of the arc-shaped groove 331, and will push outward the latching element 36 (as shown in FIG. 9). The locking plate 361 of the latching element 36 can escape from the locking notch 351 of the side bar bottom locking element 35. At this time, the lower bar top locking element 34 and the outer housing 38 are released, and the side bar 10 can move forward, allowing the side bar 10 and the lower bar 40 to form an included angle from the original straight state. When the included angle is formed, the latch pin 362 will also escape from the snap-in hole 341. Then, the grab rail 20 is pressed downward, and the lower bar 40 and the support handle 90 will move closer gradually from the original X-shaped intersection state. At this time the front tube 51 that the lower bar 40 uses to position the side bottom bar 50 is not changed, and the tail end of the support handle 90 will displace backward relatively. The tail end of the support handle 90 links the movable rod 100, allowing the movable rod 100 to move backward by a small distance. When the movable rod 100 moves backward gradually, the front pillar 101 and the rear pillar 102 of the movable rod 100 will all move backward. The front pillar 101 is disposed in the front arc-shaped chute 611 of the front sleeve 61, and at this time, the front sleeve 61 will not displace but rotate by itself, driving the front wheel set 60 to flip inward (as shown in FIG. 5, FIG. 10, and FIG. 11). Similarly, the rear pillar 102 is disposed in the rear arc-shaped chute 711 of the rear sleeve 71, and at this time, the rear sleeve 71 does not displace but rotates by itself, driving the rear wheel set 70 to flip inward, until completely folding the baby stroller 1. After the front wheel set 60 and the rear wheel set 70 flip inward (as shown in FIG. 6), the front wheel set 60 and the rear wheel set 70 will form a horizontal state to reduce the sizes of the front wheel set 60 and the rear wheel set 70, and lower the height of the folded baby stroller 1.

In the present invention, upon folding the stroller 1, the front wheel set 60 and the rear wheel set 70 are flipped altogether, without needing a second operation to flip the front wheel set 60 and the rear wheel set 70, which is very convenient in operation. In addition, the height of the folded stroller 1 is lowered, so that the folded stroller 1 can be stored easily. Furthermore, when expanding the stroller 1, the lower bar 40 and the support handle 90 change into the original X-shaped intersection state gradually from the roughly getting closer state. The side bar 10 and the lower bar 40 change into the straight state gradually from the state that they form an included angle. The movable rod 100 moves forward, the front pillar 101 and the rear pillar 102 all move forward, and the front pillar 101 is disposed in the front arc-shaped chute 611 of the front sleeve 61. At this time, the front sleeve 61 does not displace but rotates by itself, driving the front wheel set 60 to flip outward into an upright position. The rear pillar 102 is disposed in the rear arc-shaped chute 711 of the rear sleeve 71, and at this time, the rear sleeve 71 does not displace but rotates by itself, which drives the rear wheel set 70 to flip outward into an upright position, thereby completely expanding the stroller 1. This is also a one-time expansion operation, without needing a second operation to flip the front wheel set 60 and the rear wheel set 70 into the upright position.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A turn-over structure linking wheels upon folding a stroller, comprising: a pair of side bar, with that an upper side of the side bar is connected to a grab rail, a lower side of the side bar is connected to a turning lock button, the turning lock button is pivoted to a lower bar, a tail end of the lower bar is pivoted to a side bottom bar, an inner side of the side bar is provided with a push button which connects a steel cable to the turning lock button, sliding the push button releases the locking between the side bar and the lower bar, the side bar and the lower bar change into a flipped and folded state from an original straight state, a bottom end of the lower bar provides for connecting the side bottom bar, a front side of the side bottom bar is pivoted to a front wheel set, and a rear side of the side bottom bar is pivoted to a rear wheel set; and
a carrying frame, which is a frame body, with that each side of the carrying frame is pivoted to each one side bar, an upper end of a support handle is pivoted to the carrying frame, a lower end of the support handle is pivoted to a movable rod, and a middle end of the support handle is pivoted to a roughly middle position on an inner side of the lower bar, allowing the lower bar and the support handle to form an intersection state in an X-shape;
wherein the side bottom bar is provided with a front tube, a connection handle, and a rear tube, with that the connection handle connects the front tube and the rear tube, the movable rod passes through the front tube and the rear tube, a front side of the movable rod is provided with two symmetric front pillars, a rear side of the movable rod is provided with two symmetric rear pillars, an upper side on top of the front wheel set contains a front sleeve, the front sleeve is provided with two symmetric front arc-shaped chutes, the front pillar is disposed in the front arc-shaped chute, an upper side on top of the rear wheel set contains a rear sleeve, the rear sleeve is provided with two symmetric rear arc-shaped chutes, the rear pillar is disposed in the rear arc-shaped chute; when folding the baby stroller, the support handle changing into an even tilted state from a tilted state, and the movable rod being pulled backward to link the front sleeve and the rear sleeve to change direction, allowing the front wheel set and the rear wheel set to flip inward for collection altogether and simultaneously.

2. The turn-over structure linking wheels upon folding a stroller according to claim 1, wherein a bottom end of the lower bar is provided with a pivoting double rug and a short round tube, and the short round tube provides for connecting the front tube.

3. The turn-over structure linking wheels upon folding a stroller according to claim 1, wherein the front tube of the side bottom bar is provided with a front chute, the front chute provides for the front pillar of the movable rod to enter and displace, the rear tube of the side bottom bar is provided with a rear chute, and the rear chute provides for the rear pillar of the movable rod to enter and displace.

4. The turn-over structure linking wheels upon folding a stroller according to claim 1, wherein a top of the front wheel set is provided with a front horizontal cylinder, the front horizontal cylinder is combined with the front sleeve by a front insert pin to allow the front horizontal cylinder and the front sleeve to change direction simultaneously, whereas a top of the rear wheel set is provided with a rear horizontal cylinder, and the rear horizontal cylinder is combined with the rear sleeve by a rear insert pin to allow the rear horizontal cylinder and the rear sleeve to change direction simultaneously.

5. The turn-over structure linking wheels upon folding a stroller according to claim 1, wherein a gap is disposed between the front tube and the rear tube, the connection handle is disposed in the gap, and the gap provides for the movement of a pivot place between the movable rod and the support handle.

6. The turn-over structure linking wheels upon folding a stroller according to claim 1, wherein a top end of the support handle is connected to the carrying frame by a double lug, and a bottom end of the support handle is pivoted to the lower bar by a bottom ring.

7. The turn-over structure linking wheels upon folding a stroller according to claim 1, wherein the push button outside the inner side of the side bar is provided with a combining pillar, the inner side of the side bar is provided with a straight slot which provides for the combining pillar to displace, the combing pillar is combined with a pull block, the pull block connects a steel cable, a top end of the pull block abuts a spring, and an interior of the side bar is positioned with a limiting element to assemble the pull block and the spring inside the side bar.

8. The turn-over structure linking wheels upon folding a stroller according to claim 1, wherein the turning lock button includes an inner housing, a micro compression spring, a turning element, a lower bar top locking element, a side bar bottom locking element, a latching element, a compression spring, and an outer housing, with that the inner housing has a shaft, the outer housing has a shaft hole, the shaft and the shaft hole are combined together by a stud bolt, and the inner housing and the outer housing are combined to assemble the micro compression spring, the turning element, the lower bar top locking element, the side bar bottom locking element, the latching element, and the compression spring, with that a lower side of the inner housing is provided with a lower handle, the turning element is linked by the steel cable which is connected to the push button to rotate, the turning element abuts the micro compression spring, two symmetric arc-shaped grooves are disposed outside the turning element, the depth of arc-shaped groove increases gradually, the lower bar top locking element is a round plate and is provided with plural snap-in holes, a lower side of the lower side top locking element is provided with a secondary lower handle, and the secondary lower handle is combined to the lower handle of the inner housing, with that after the secondary lower handle is combined with the lower handle, the secondary lower handle and the lower handle are disposed in the top end of the lower bar, and with that the side bar bottom locking element is a round ring, an interior of the round ring is provided with two locking notches, an upper side of the side bar bottom locking element is provided with a secondary upper handle, the latching element is a round plate, an outer periphery of the round plate is provided with two protruded locking plates, an inner side of the round plate is provided with plural protruded latch pins, the locking plate is locked in the locking notch of the side bar bottom locking element, the latch pin is inserted in the snap-in hole of the lower bar top locking element, an outer side of the latching element is abutted by the micro compression spring in the outer housing, an upper side of the outer housing is provided with an upper handle, a positioning side upper handle is combined with the upper handle and the secondary upper handle of the side bar locking element, followed by being disposed in the bottom end of the side bar.

9. The turn-over structure linking wheels upon folding a stroller according to claim 1, wherein a front end of the carrying frame is pivoted to a front pull handle.

10. The turn-over structure linking wheels upon folding a stroller according to claim 1, wherein three bridging rods are connected between the two side bottom bars.
